(19) United States
(12) Patent Application Publication
(10) Pub. No.: US 2006/0069733 A1
(43) Pub. Date: Mar. 30, 2006

(54) Detection and removal of information in files

(75) Inventors: Lauren Nicole Antonoff, Seattle, WA (US); Khai Weyn Ong, Bellevue, WA (US); Rhae-Christie Shaw, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/261,963

(22) Filed: Oct. 28, 2005

Related U.S. Application Data
(63) Continuation-in-part of application No. 10/954,638, filed on Sep. 30, 2004.

(51) Int. Cl. G06F 15/16

(52) U.S. Cl. 709/206

(57) ABSTRACT

A computer system includes an application programmed to create a document, and a component including at least one internal module programmed to examine and modify the document to remove hidden information or metadata. The computer system also includes a communications interface for an external module programmed to examine and modify the document. The communications interface is programmed to allow the component to communicate with the external module.

### RELATED APPLICATION

This application is a continuation-in-part of U.S. patent application Ser. No. 10/954,638 filed on Sep. 30, 2004, the entirety of which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### BACKGROUND

A computer file includes both the information (or data) making up the file as well as metadata, or data relating to attributes of the file itself. For example, a file typically includes metadata such as the document creator's name, the date the file was last saved, and the date the file was last printed. In addition, some files such as, for example, a MICROSOFT Word document, can include hidden information that is not readily apparent to a user. For example, a Word document can include hidden information in the form of tracked changes and comments that may not be visible when the document is opened in certain document views.

When documents are shared between individuals, the metadata and/or hidden information in the documents can be problematic. For example, many important documents are communicated between individuals by attaching the documents to electronic mails. However, whenever a document is shared in its electronic form, the document has the potential of containing embarrassing or otherwise problematic metadata and hidden information.

For example, a consultant may take a document previously created for a first client and revise portions of the document with information related to a project for a second client. The consultant may not realize that the “track changes” option has been turned on before the revisions are made, especially if the consultant's document view is set to hide the tracked changes on the screen. When the consultant electronically mails the revised document to the second client, the second client can merely switch document views to view information relating to the first client that was deleted during revision of the document by the consultant. This can potentially lead to the inadvertent disclosure of the first client's confidential information to the second client.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect relates to computer system including an application programmed to create a document, and a component including at least one internal module programmed to examine and modify the document to remove hidden information and metadata. The computer system also includes a communications interface for an external module programmed to examine and modify the document, wherein the communications interface is programmed to allow the component to communicate with the external module.

Another aspect relates to method for examining and removing information from a document, the method including: allowing a user to create a document; providing a menu including an item programmed to allow for finalization of the document; upon selection of the item, loading a component programmed to examine the document to identify information as part of the finalization of the document; and presenting the user with results of the examination of the document by the component.

Another aspect relates to computer-readable medium having computer-executable instructions for performing steps including: allowing a user to create a document; providing a menu including an item programmed to allow for finalization of the document; upon selection of the item, loading a component programmed to examine the document to identify information as part of the finalization of the document; and presenting the user with results of the examination of the document by the component.

### DESCRIPTION OF THE DRAWINGS

Reference will now be made to the accompanying drawings, which are not necessarily drawn to scale, and wherein:

FIG. 1 illustrates an example general purpose computer system;

FIG. 2 illustrates an example method for detecting and removing metadata and hidden information from files attached to electronic mail;

FIG. 3 illustrates an example electronic mail including an attached file;

FIG. 4 illustrates an example computing environment including a client and a server;

FIG. 5 illustrates an example method for detecting and removing metadata and hidden information from files uploaded to a server;

FIG. 6 illustrates another example computer system;

FIG. 7 illustrates an example application on the computer system of FIG. 6;

FIG. 8 illustrates an example menu of the application of FIG. 7;

FIG. 9 illustrates an example user interface of a component of the application of FIG. 7;

FIG. 10 illustrates another example user interface of the component of the application of FIG. 7;

FIG. 11 illustrates another example user interface of the component of the application of FIG. 7;

FIG. 12 illustrates an example method for finalizing a file;

FIG. 13 illustrates another example method for examining and modifying information in a file;

FIG. 14 illustrates another example computer system; and

FIG. 15 illustrates another example method for examining and modifying information in a file.

### DETAILED DESCRIPTION

Example embodiments will now be described more fully hereinafter with reference to the accompanying drawings. These embodiments are provided so that this disclosure will be thorough and complete. Like numbers refer to like elements throughout.

Example embodiments disclosed herein relate to systems and methods for examining and modifying document. For example, some embodiments disclosed herein relate to systems and methods that detect metadata and hidden information in documents and automatically alert the user and/or remove the metadata and hidden information upon sharing of the documents. In other embodiments disclosed herein, systems and methods examine and modify documents.

Examples of information, including metadata and hidden information, that can be associated with a particular computer file or document include the following: comments; revisions (tracked changes); deleted text; version information; electronic mail headers; routing slip information; personal summary information; user name (e.g., name and/or initials); prior authors and editors; printer path name; template name, ink comments/annotations; scenario comments, unique suite identifiers (e.g., MICROSOFT Office software identifiers); document workspace information (e.g., template information, computer name); and file path information. This list is not exhaustive. Other types of information can also be associated with a file.

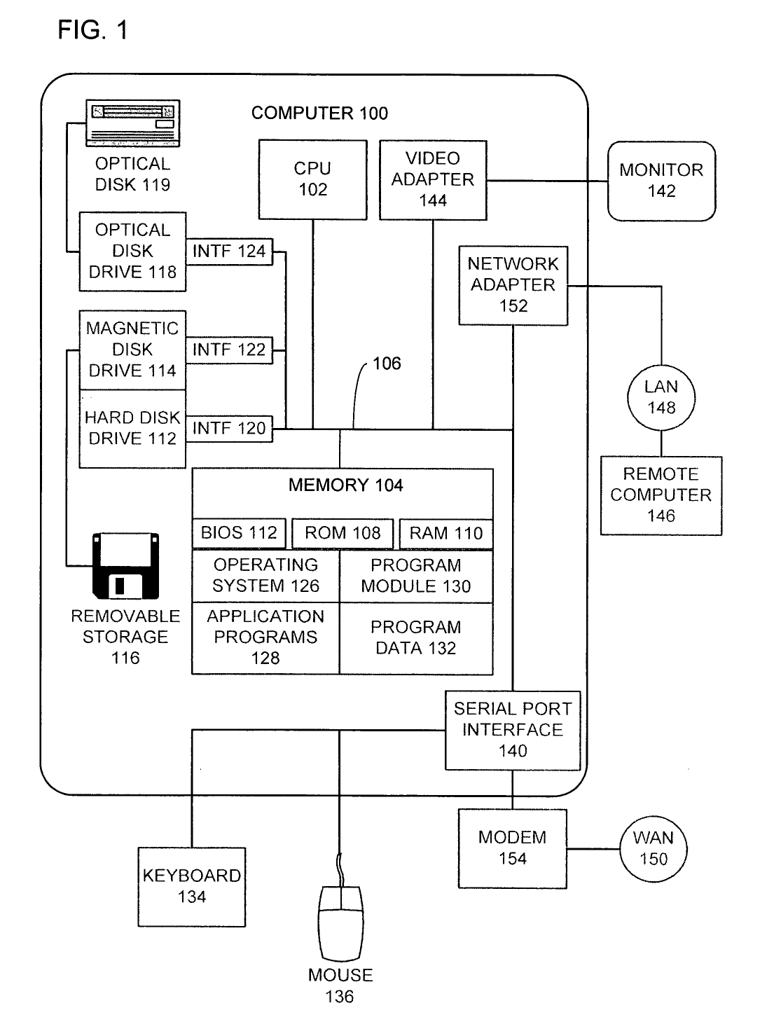

Referring now to FIG. 1, an example computer system 100 is illustrated. Computer system 100 can take a variety of forms such as, for example, a desktop computer, a laptop computer, and a hand-held computer. In addition, although computer system 100 is illustrated, the systems and methods disclosed herein can be implemented in various alternative computer systems as well.

The system 100 includes a processor unit 102, a system memory 104, and a system bus 106 that couples various system components including the system memory 104 to the processor unit 102. The system bus 106 can be any of several types of bus structures including a memory bus, a peripheral bus and a local bus using any of a variety of bus architectures. The system memory includes read only memory (ROM) 108 and random access memory (RAM) 110. A basic input/output system 112 (BIOS), which contains basic routines that help transfer information between elements within the computer system 100, is stored in ROM 108.

The computer system 100 further includes a hard disk drive 112 for reading from and writing to a hard disk, a magnetic disk drive 114 for reading from or writing to a removable magnetic disk 116, and an optical disk drive 118 for reading from or writing to a removable optical disk 119 such as a CD ROM, DVD, or other optical media. The hard disk drive 112, magnetic disk drive 114, and optical disk drive 118 are connected to the system bus 106 by a hard disk drive interface 120, a magnetic disk drive interface 122, and an optical drive interface 124, respectively. The drives and their associated computer-readable media provide nonvolatile storage of computer readable instructions, data structures, programs, and other data for the computer system 100.

Although the example environment described herein can employ a hard disk 112, a removable magnetic disk 116, and a removable optical disk 119, other types of computer-readable media capable of storing data can be used in the example system 100. Examples of these other types of computer-readable mediums that can be used in the example operating environment include magnetic cassettes, flash memory cards, digital video disks, Bernoulli cartridges, random access memories (RAMs), and read only memories (ROMs).

A number of program modules can be stored on the hard disk 112, magnetic disk 116, optical disk 119, ROM 108, or RAM 110, including an operating system 126 such as the WINDOWS operating system from Microsoft Corporation, one or more application programs 128, other program modules 130, and program data 132.

A user may enter commands and information into the computer system 100 through input devices such as, for example, a keyboard 134, mouse 136, or other pointing device. Examples of other input devices include a toolbar, menu, touch screen, microphone, joystick, game pad, pen, satellite dish, and scanner. These and other input devices are often connected to the processing unit 102 through a serial port interface 140 that is coupled to the system bus 106. Nevertheless, these input devices also may be connected by other interfaces, such as a parallel port, game port, or a universal serial bus (USB). An LCD display 142 or other type of display device is also connected to the system bus 106 via an interface, such as a video adapter 144. In addition to the display 142, computer systems can typically include other peripheral output devices (not shown), such as speakers and printers.

The computer system 100 may operate in a networked environment using logical connections to one or more remote computers, such as a remote computer 146. The remote computer 146 may be a computer system, a server, a router, a network PC, a peer device or other common network node, and typically includes many or all of the elements described above relative to the computer system 100. The network connections include a local area network (LAN) 148 and a wide area network (WAN) 150. Such networking environments are commonplace in offices, enterprise-wide computer networks, intranets, and the Internet.

When used in a LAN networking environment, the computer system 100 is connected to the local network 148 through a network interface or adapter 152. When used in a WAN networking environment, the computer system 100 typically includes a modem 154 or other means for establishing communications over the wide area network 150, such as the Internet. The modem 154, which can be internal or external, is connected to the system bus 106 via the serial port interface 140. In a networked environment, program modules depicted relative to the computer system 100, or portions thereof, may be stored in the remote memory storage device. It will be appreciated that the network connections shown are examples and other means of establishing a communications link between the computers may be used.

The embodiments described herein can be implemented as logical operations in a computing system. The logical operations can be implemented (1) as a sequence of computer implemented steps or program modules running on a computer system and (2) as interconnected logic or hardware modules running within the computing system. This implementation is a matter of choice dependent on the performance requirements of the specific computing system. Accordingly, the logical operations making up the embodiments described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the disclosure. This software, firmware, or similar sequence of computer instructions may be encoded and stored upon computer readable storage medium and may also be encoded within a carrier-wave signal for transmission between computing devices.

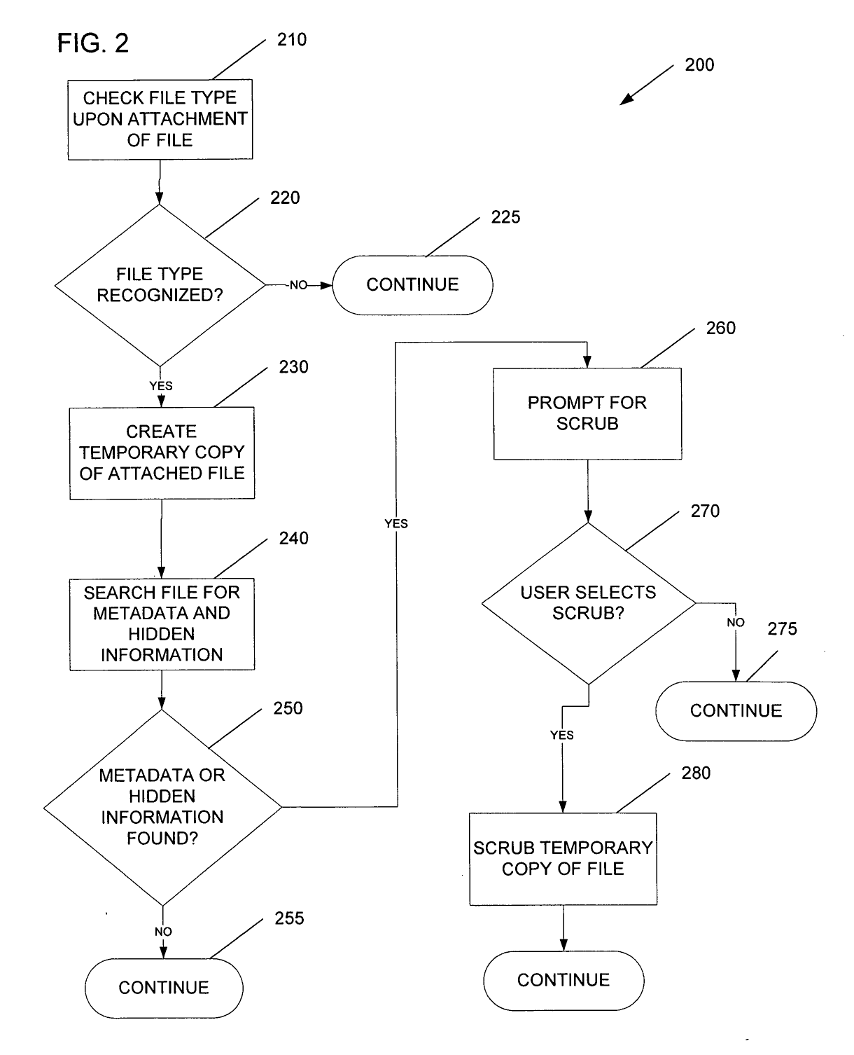

Referring now to FIG. 2, an example method 200 for removing metadata and hidden information in files attached to electronic mail is shown. At operation 210, the file type (i.e., the type of information stored in the file, usually indicated by the extension of the file) of a file is checked when the file is attached to an electronic mail. At operation 220, a determination is made regarding whether the file type of the attached file is recognized as one potentially including metadata or hidden information. Only certain types of files include metadata and hidden information, so only certain types of files are examined for this information. In the example shown, the following types of files are recognized as potentially including metadata and hidden information: MICROSOFT Word documents; MICROSOFT EXCEL spreadsheet software documents; and MICROSOFT POWERPOINT presentation graphics program documents. In other embodiments, other file types can also be included.

If the file type of the attached file is not recognized, control is passed to operation 225 and standard operation continues. If the file type is recognized as potentially including metadata and hidden information, control is passed to operation 230, and a temporary copy of the file is made for analysis. In some embodiments, a temporary copy of the file is already made by the electronic mail program such as, for example, MICROSOFT OUTLOOK messaging and collaboration client, and this copy is analyzed. In other alternative embodiments, the original file itself is analyzed and a temporary copy is therefore not made.

Next, in operation 240, the file is searched for metadata and hidden information.

In one embodiment, the file is a container comprising multiple parts. One or more of the parts are based on the extensible mark-up language (XML). For example, documents in the MICROSOFT Word 2003 document format are made up of multiple parts including several XML-based parts. A program such as MICROSOFT XML (MSXML) Parser can be used to parse the XML-based parts of the file to identify metadata and hidden information located in known areas of the XML schema. In one embodiment, an extensible stylesheet language transformation (XSLT) stylesheet is applied to the XML-based portions of the document using the MSXML Parser facilities. The MSXML Parser traverses the source XML tree of the file and writes output that signals the presence of, for example, hidden information such as tracked changes.

For example, the following example pseudocode illustrates a fragment of an XML document. The fragment includes the sentence “Here's a comment.” A comment (i.e., “This is not good”) is anchored to the last word of the sentence (i.e., “comment”).

```
<w:p>
    <w:r><w:t>Here's a </w:t></w:r>
    <aml:annotation aml:id=“0” w:type=“Word.Comment.Start”/>
    <w:r><w:t>comment.</w:t></w:r>
    <aml:annotation aml:id=“0” w:type=“Word.Comment.End”/>
    <w:r>
        <w:rPr><w:rStyle w:val=“CommentReference”/></w:rPr>
        <aml:annotation aml:id=“0” aml:author=“KHAIO-DEV”
    aml:createdate=“2004-08-16T17:18:00Z” w:type=“Word.Comment”
    w:initials=“DEV”>
            <aml:content>
                <w:p>
                    <w:pPr><w:pStyle
                w:val=“CommentText”/></w:pPr>
                    <w:r>
                        <w:rPr>
                            <w:rStyle
                        w:val=“CommentReference”/>
                        </w:rPr>
                        <w:annotationRef/>
                    </w:r>
                    <w:r><w:t>This is not good.</w:t></w:r>
                </w:p>
            </aml:content>
        </aml:annotation>
    </w:r>
</w:p>
```

The above XML can be parsed, and XML tags indicating metadata and hidden information can be identified and removed. For example, in the above example pseudocode, the tag “aml:annotation” is identified as possibly including hidden information and, if desired, scrubbed so that the final scrubbed XML pseudocode would look like the following.

```
<w:p>
    <w:r><w:t>Here's a </w:t></w:r>
    <w:r><w:t>comment.</w:t></w:r>
</w:p>
```

In an alternative embodiment, the file is searched for metadata and hidden information by loading the file in the background into the native program which created the file. For example, if the attached file is a MICROSOFT Word document, the document is loaded in the background by MICROSOFT Word software and then analyzed within MICROSOFT Word software to identify if the document includes metadata and/or hidden information.

Next, in operation 250, a determination is made regarding whether the file includes metadata or hidden information. If the file does not include such information, control is passed to operation 255 and standard operation continues. If the file does include metadata or hidden information, control is passed to operation 260, and the user is prompted to see if the user wants to “scrub” (i.e., remove) the file of such information.

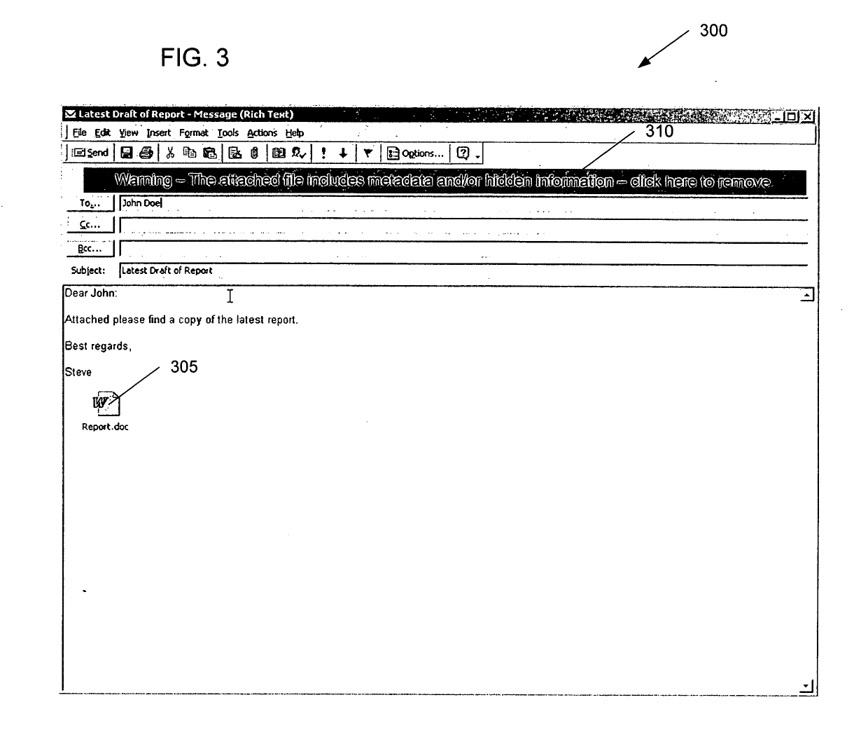

For example, an example electronic mail 300 including an attached file 305 is illustrated in FIG. 3. If a determination is made upon attachment that file 305 includes metadata or hidden information, the user is alerted by a banner 310 placed in the header of electronic mail 300. The user can then click on banner 310 to remove the metadata and hidden information. Alternatively, if the user does not wish to remove the metadata and hidden information, the user can choose to simply ignore the banner 310 and continue to draft and send the electronic mail 300.

In other embodiments, different methods of alerting the user of metadata and hidden information can be used. For example, in one embodiment, the user is prompted by a dialog box that pops up warning of metadata and hidden information (i) when a file including metadata or hidden information is attached to an electronic mail, or (ii) when the user actually sends the electronic mail. In another embodiment, any files attached to an electronic mail can simply be automatically scrubbed when sent without any prompting or input from the user. For example, the user can create a rule using the MICROSOFT OUTLOOK messaging and collaboration client Rule Wizard that automatically checks and scrubs any attachments to electronic mail sent by the user.

Referring back to FIG. 2, once the user has been prompted in operation 260, control is then passed to operation 270 where it is determined whether or not the user wants to scrub the attached file. If the user chooses not to scrub the file, control is passed to operation 275 and standard operation continues. If the user chooses to scrub the file, control is passed to operation 280, where the temporary file is scrubbed. In some embodiments, if a separate temporary file was made to analyze and scrub, the temporary scrubbed file is the copy sent out with the electronic mail.

Generally, a file is scrubbed by removing some or all of the metadata and/or hidden information from the file. For example, another XSLT stylesheet that locates and removes hidden information can be applied to the document to remove metadata and hidden information. In one example, the MSXML API used to carry out XSLT to remove metadata and hidden information is IXMLDOMNode: transformNode (IXMLDOMNode *stylesheet, BSTR *xmlString).

In some embodiments, the user is provided with a list of the metadata and/or hidden information contained in a given file, and the user is allowed to decide which, if any, of the different types of metadata and/or hidden information to remove. For example, the user may choose to remove metadata associated with the authorship name and date, but to keep tracked changes.

In one example embodiment, method 200 is implemented in one or more modules provided as add-ins to MICROSOFT OUTLOOK messaging and collaboration client. The modules can monitor attached files, alert the user when attached files contain metadata and/or hidden information, and remove any such metadata and hidden information from the attached files.

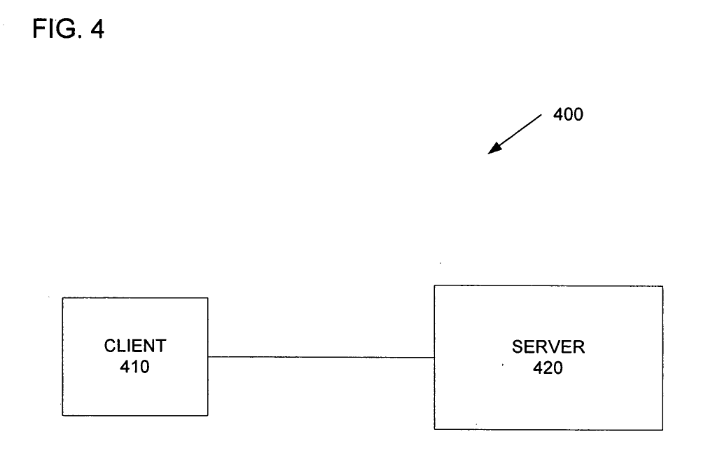

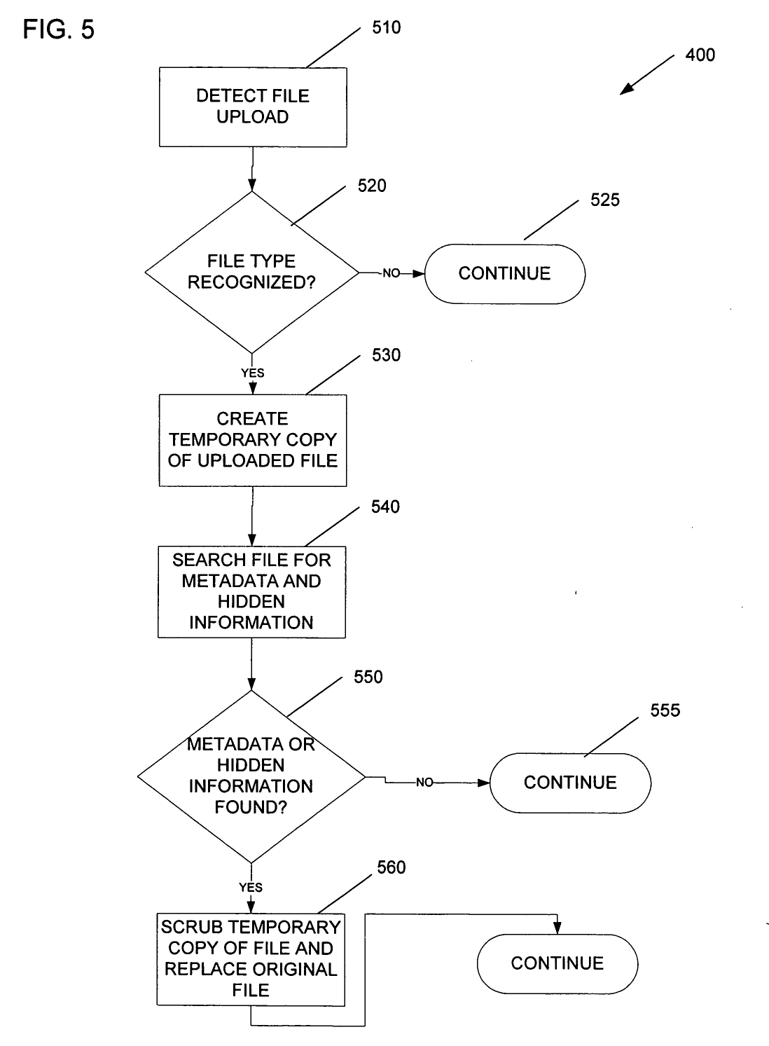

Referring now to FIGS. 4 and 5, in another embodiment metadata and hidden information can be scrubbed from a file that is uploaded to a server such as a collaboration server or a document management server. For example, a user can share a file with other users by uploading the file to a MICROSOFT SHAREPOINT Portal Server. However, it may be desirable to remove metadata and/or hidden information before the file is made available to other users.

In FIG. 4, an example computing environment 400 is illustrated including a client 410 configured in a manner similar to computing system 100 described above. Environment 400 also includes a server 420 in data communication with the client 410, such as a MICROSOFT SHAREPOINT Portal Server. The client 410 can upload a file to server 420. Server 420 is configured to scrub the file automatically or upon prompting from the user when the file is uploaded to server 420.

Referring now to FIG. 5, an example method 500 for scrubbing a file uploaded to a server such as server 420 is illustrated. At operation 510, the server or a processes running thereon detects that a file has been uploaded. Next, at operation 520, the server determines whether the file type for the file is recognized. If the file type is not recognized, control is passed to operation 525 and standard processing of the upload continues. If the file type is recognized (e.g., MICROSOFT Word documents, MICROSOFT EXCEL spreadsheet software documents, and MICROSOFT POWERPOINT presentation graphics program documents), control is passed to operation 530, where a temporary copy of the file is made.

Next, in operation 540, the file is searched to identify any metadata or hidden information. For example, as noted above, Word 2003 word processing documents, EXCEL 2003 spreadsheet software documents, and POWERPOINT 2003 presentation graphics program documents each include XML-based content. The XML-based portions of these documents can be parsed to identify XML tags indicative of metadata and hidden information.

Next, in operation 550, a determination is made regarding whether metadata or hidden information is found in the file. If no metadata or hidden information is found in the file, control is passed to operation 555 and standard processing of the upload continues and any temporary copies of the file made for analysis can be deleted. If metadata or hidden information is found, control is passed to operation 560, and the temporary file is automatically scrubbed and written over the original file.

In alternative embodiments, the user is given a choice regarding whether or not to scrub the uploaded file. In another embodiment, the administrator of the server can develop a policy to define which files are scrubbed and whether scrubbing is automatic or prompted.

In addition to the automated examination of documents for metadata and hidden information, in some embodiments disclosed herein a user can manually initiate examination and modification of a document.

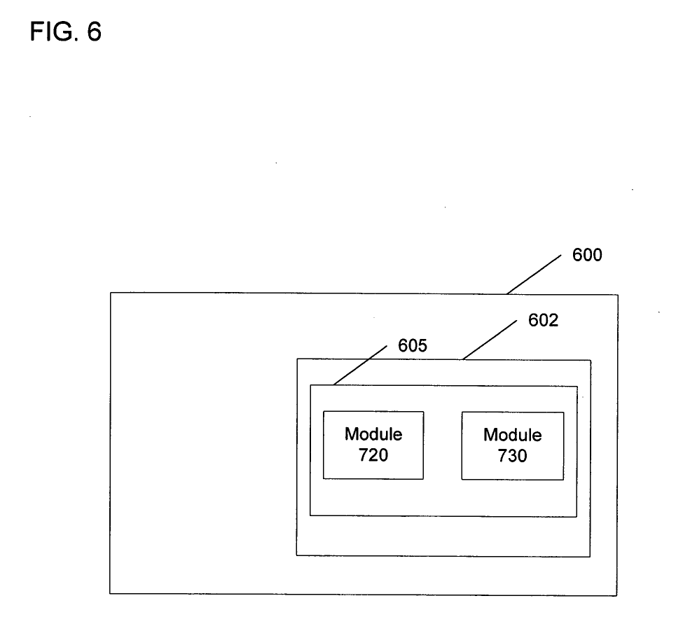

For example, referring now to FIG. 6, an example computer system 600 including an application 602 is shown. Computer system 600 is similar to computer system 100 described above.

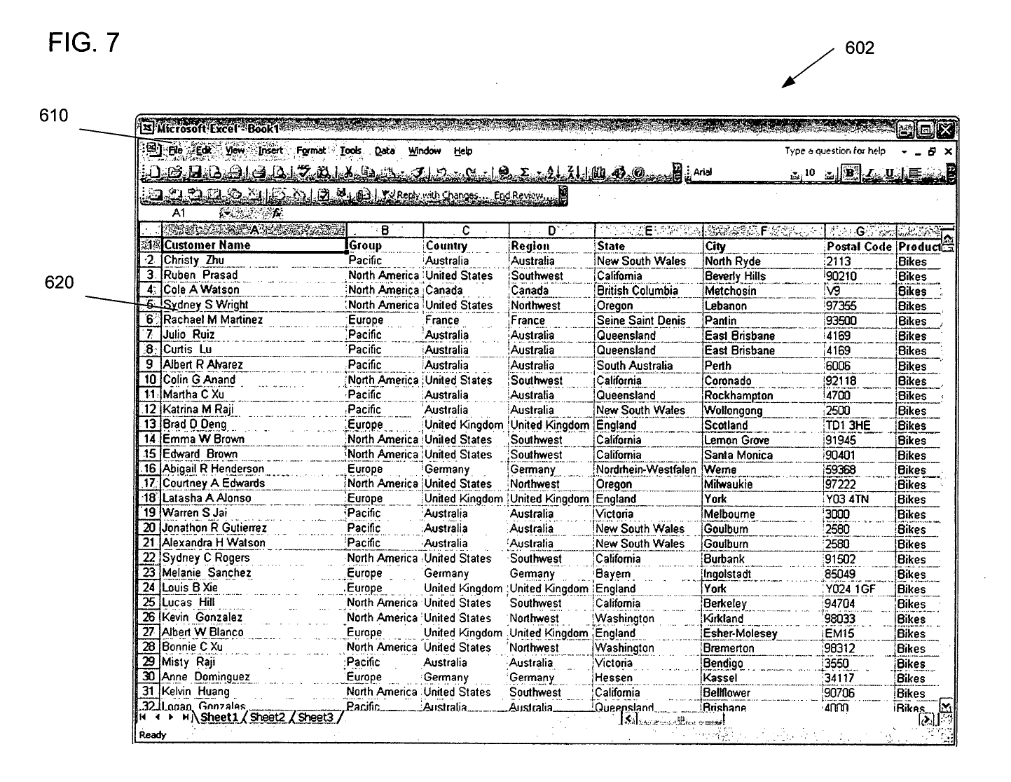

In the example shown, application 602 is the EXCEL spreadsheet software application from Microsoft Corporation. Other programs can also be used. Examples of such programs include, without limitation, Word software and POWERPOINT presentation graphics program software from Microsoft Corporation. Application 602 includes a component 605 with modules 720, 730 that can be used to examine and modify document 620 (e.g., identify and remove comments/revisions and metadata), as described below with reference to FIG. 7.

Referring now to FIG. 7, application 602 is used to create a document 620. During the creation and editing of document 620, document 620 can include information that may be desirable to identify and modify before the user shares document 620 with others. Examples of such information in document 620, as described above, can include metadata and hidden information such as: comments; revisions (tracked changes); deleted text; version information; electronic mail headers; routing slip information; personal summary information; user name (e.g., name and/or initials); prior authors and editors; printer path name; template name, ink comments/annotations; scenario comments, unique suite identifiers (e.g., MICROSOFT Office identifiers); document workspace information (e.g., template information, computer name); and file path information. Other examples of information that can be desirable to identify and modify can include: profanity; properties from a document management systems; geopolitical terms and phrases (e.g., terms and phrase not appropriate in different languages); client information (e.g., client names in healthcare or legal setting); security information (e.g., identification of images in a document (e.g., if an image is behind another image, and removal of images)); web publishing security (e.g., identification if the same color text is on same color background); identification of macros; identification of connections to external sources (e.g., fields and charts that update, live data). This list is not exhaustive. Other types of information can also be associated with a document.

Referring again to FIG. 7, a toolbar 610 is included with application 602. The user can select one or more dropdown menus from toolbar 610.

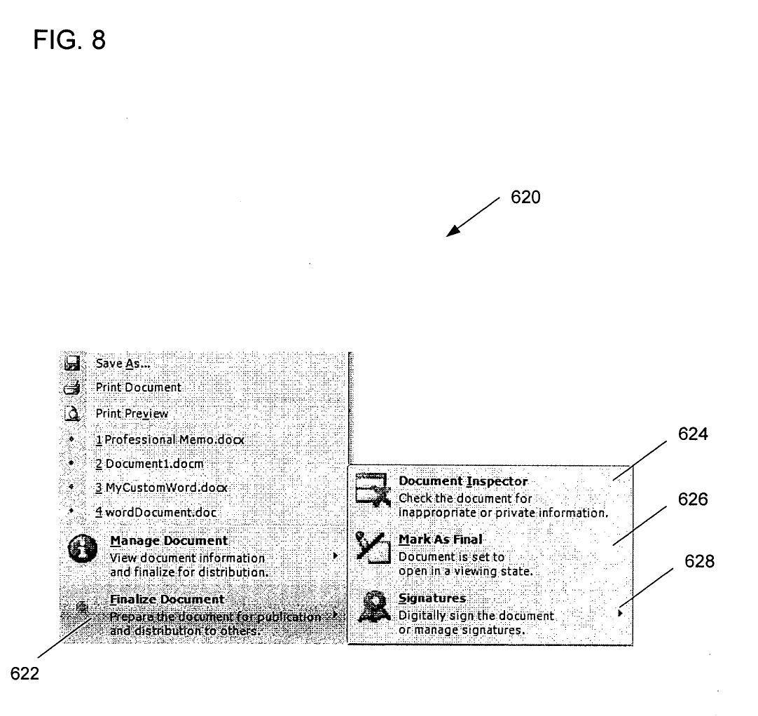

For example, referring now to FIG. 8, an embodiment of a dropdown menu 621 that is accessed from the “File” item of toolbar 610 is shown. Menu 621 includes an item 622 labeled “Finalize Document.” In the example shown, the user can manually select item 622 once a document is complete to perform steps to “finalize” the document, or otherwise place the document in a form such that it can be shared with others. In the example shown and as described below, these items for finalization are all placed in one location (e.g., item 622) to allow the user to easily access the items during finalization of document 620.

One selection under item 622 is an item 624 labeled “Document Inspector.” As described further below, the user can select item 622 to initiate component 605 to examine and modify information in document 620 as part of finalizing document 620. Another selection under item 622 includes item 626 labeled “Mark As Final,” which allows the user to mark the document to be opened in a viewing state (e.g., read-only) as part of finalizing document 620. Another selection under item 622 includes item 628 labeled “Signatures,” which allows the user to digitally sign the document as part of finalizing document 620. Other selections are possible.

Although in the example shown component 605 can be accessed using toolbar 610, in other embodiments component 605 can be accessed in other manners as well. For example, a user can use keyboard shortcuts to access component 605. In addition, in other embodiments, component 605 can be accessed prior to finalization of the document. For example, in some embodiments, component 605 also can be accessed by selecting the “Tools” item from toolbar 610.

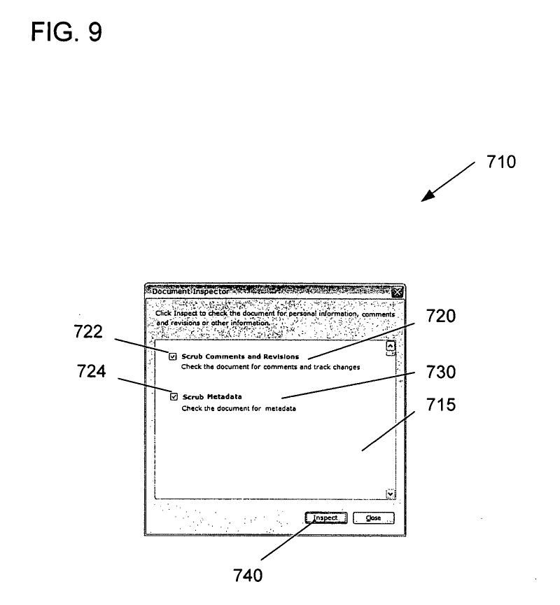

Referring now to FIG. 9, once the user selects item 624 from menu 621, application 602 shows the user an example interface 710 associated with component 605. Interface 710 includes a panel 715 with a list of modules 720, 730. Modules 720, 730 are generally programmed to: (i) examine a document; and (ii) modify the document. In the example shown, modules 720, 730 are used to examine document 620 to identify information and to modify document 620. In alternative embodiments, more or fewer modules having varying functionality can be used.

For example, in the illustrated embodiment, module 720 is used to identify comments and revisions, and module 730 is used to identify metadata. Checkboxes 722, 724 associated with each module 720, 730 can be used to select the modules that are used to examine document 620. In other embodiments, other methods for selecting the modules can be used such as, for example, clicking on the description of each module to select the module for use.

In the example shown, both modules 720, 730 are selected to examine document 620. In other examples, the user can select only one of modules 720, 730 to examine document 620. In yet other embodiments, additional modules are listed in pane 715, and the user can select one or more of the additional modules to examine 620. For example, as described further below, one or more external modules can be listed in pane 715 and, once selected by the user, the external modules are used to examine document 620.

Once the user selects modules 720, 730, the user can select button 740 to begin the examination of document 620 using the selected modules 720, 730. In one example, document 620 is examined by modules 720, 730 in a manner similar to that described above in one of methods 200 and 400.

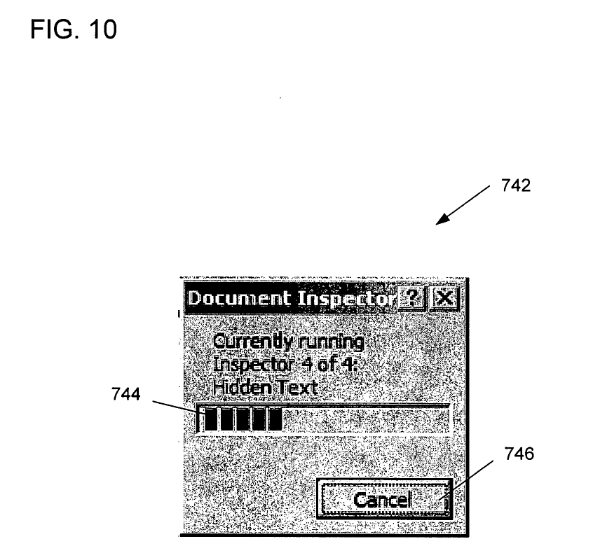

Referring now to FIG. 10, during examination of document 620 by component 605, the user can be periodically updated as to the progress of the examination. For example, as shown, component 605 can provide a user interface 742 including a progress bar 744, and the progress bar 744 can be updated periodically to indicate the status of the examination. User interface 742 can also include a cancel button 746 that, when selected by the user, stops examination of document 620. When examination is complete or the user selects cancel button 746, the user interface 742 with the progress bar 744 can be removed. Other methods for indicating progress can also be used.

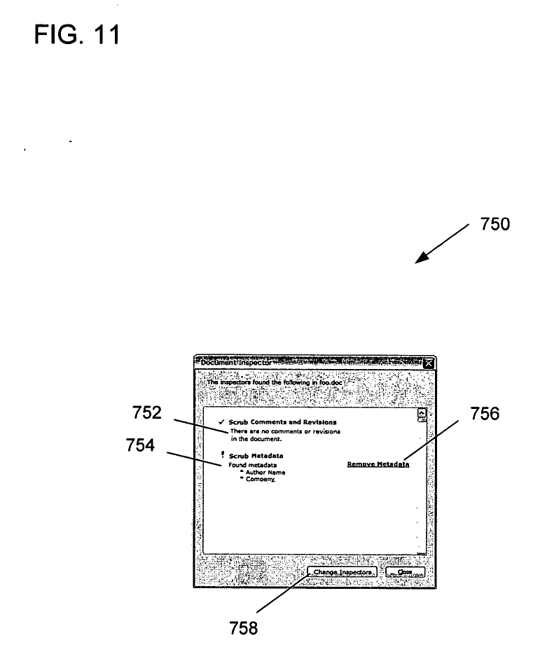

Referring now to FIG. 11, once examination of document 620 is completed, application 602 shows the user an example interface 750 providing information regarding the results of the examination. For example, interface 750 lists each module that was used during examination, and the results of the examination for each module. For example, entry 752 lists the results of the examination by module 720 and identifies any information found in document 620. In the example shown, no information (i.e., comments/revisions) was found in document 620, and an icon 753 is provided to indicate that no information was identified by module 720.

Entry 754 lists the results of the examination by module 730 and identifies any information found in document 620. In the example shown, entry 754 lists metadata including “Author Name” and “Company” associated with document 620. In the example shown, entry 754 lists a generic name for each type of information found in document 620, such as “Author Name.” In alternative embodiments, entry 754 can list the actual information or a synopsis of information that is found, such as “John Doe” for the actual author's name.

Since metadata has been identified by module 730, entry 754 includes an icon 755 to indicate that information has been found. Entry 754 also includes a link 756 that can be selected by the user to modify document 620. For example, the user can select link 756 to remove the identified metadata as described below. If the user does select link 756, module 730 can modify document 620 to remove the metadata 620 in a manner similar to that described above in one of methods 200 and 400

In addition, a button 758 is provided on interface 750 that allows the user to change the modules that are used to examine a document. For example, if the user selects button 758, interface 710 is shown again (see FIG. 9) so that the user can select/deselect the modules to use in reexamination of document 620. Once the user selects/deselects the desired modules, examination of document 620 is performed again.

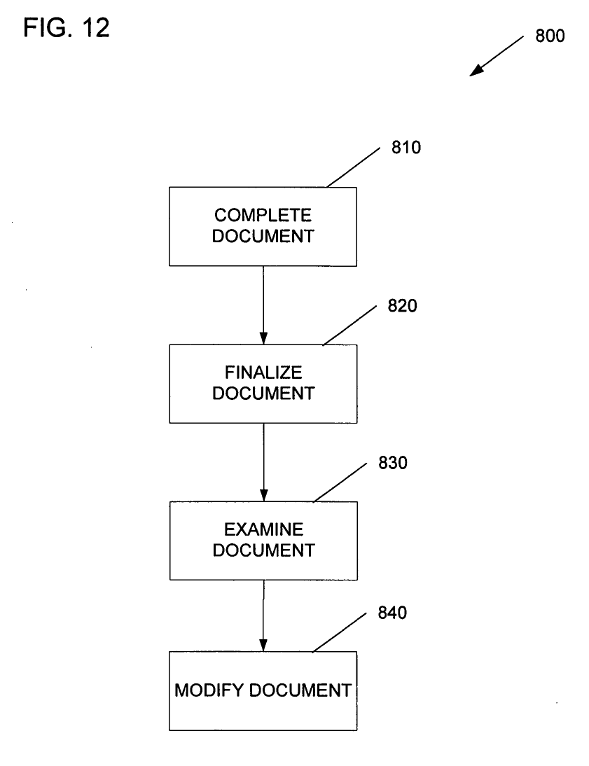

Referring now to FIG. 12, an example method 800 for finalizing a document is shown. At operation 810, the user completes a document using an application such as application 602 described above. Next, in operation 820, the user finalizes the document. As part of finalization of the document, control is passed to operation 830 and the user requests that the document be examined for information such as metadata, hidden information, and/or other information as described above. Next, at operation 840, the user can decide to modify the document by, for example, removing any information that is identified as a result of the examination.

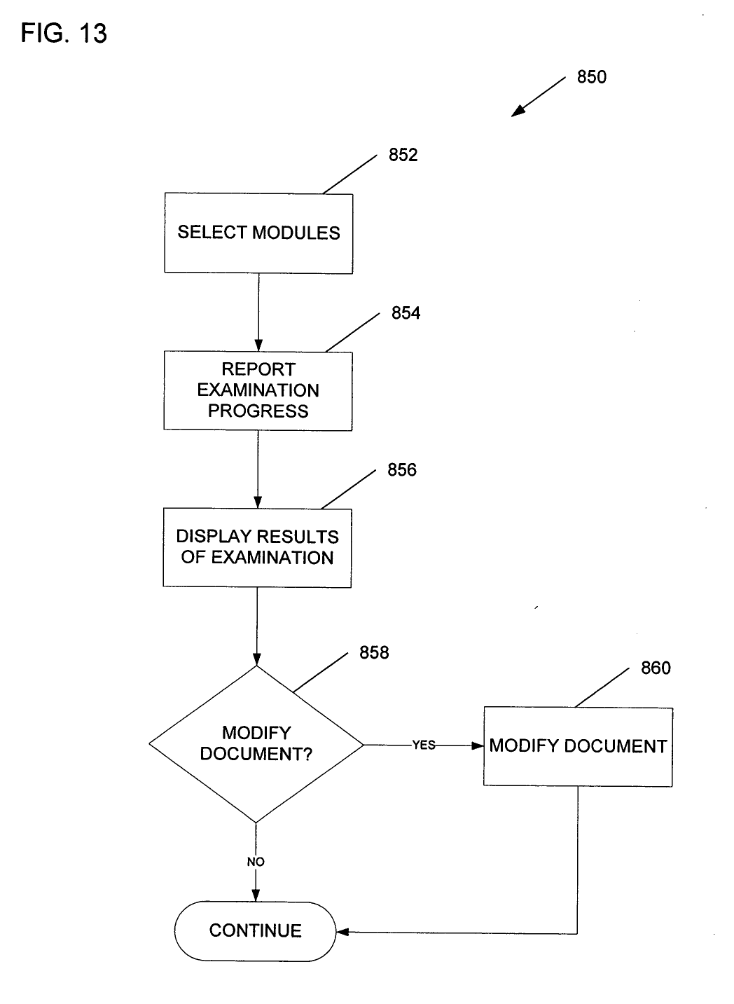

Referring now to FIG. 13, an example method 850 for examination and modification of a document is shown. At operation 852, the user selects which modules are to be used to examine the document. Next, at operation 854, examination of the document is conducted, and the user is presented with the progress of the examination.

Next, at operation 856, once examination is complete the user is presented with the results of the examination. Next, at operation 858, a determination is made regarding whether the user wishes to modify the document to, for example, remove the identified information. If the user wants to remove the information, control is passed to operation 860, and the information is removed.

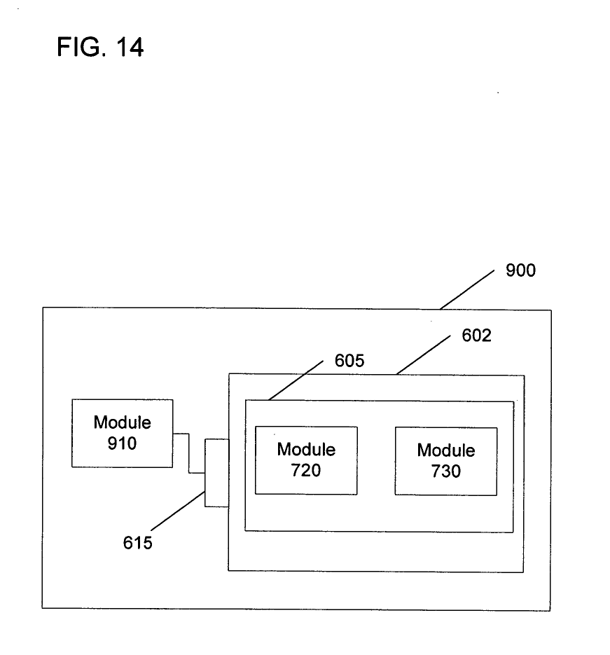

Referring now to FIG. 14, another example computer system 900 is shown. Computer system 900 is similar to that of computer system 600 described above. For example, computer system 900 includes application 602 including component 605 with modules 720, 730.

In the illustrated embodiment, modules 720, 730 of component 605 are referred to as “internal” modules, in that modules 720, 730 are implemented as part of component 605. For example, when component 605 of application 602 is delivered to the user, component 605 includes “internal” modules 720, 730 that form a part of component 605 and application 602.

Example computer system 900 is also shown as including an “external” module 910 that can be associated with application 602 and component 605. Module 910 is similar to modules 720, 730, in that module 910 can be used both to examine document 620 and to modify document 620. However, module 910 is “external” in that it can be developed and delivered separately from component 605 as an independent software module separate from component 605 and application 602. External module 910 can be used to extend the functionality of component 605 to, for example, identify additional information in document 620 and to modify document 620 in view of the identified additional information.

For example, external module 910 can be developed separately from application 602 and component 605. In one embodiment, as described below, a third party can create external module 910 and associate module 910 with component 605 to examine and modify a document as desired. In example embodiments, application 602 with component 605 is delivered to end users with only internal modules such as modules 720, 730, and any external modules are provided separately by, for example, third parties other than the party that developed component 605. In other embodiments, application 602 with component 605 is delivered to end users with both internal and external modules, and additional external modules can be provided separately by third parties.

In the example shown, module 910 includes the following methods and properties:

| Type | Name | | Description |
|---|---|---|---|
| Property | Name (read-only) | | Name of module. |
| Property | Description (read only) | | Description of information that |
| | | | the module can identify and |
| | | | remove. |
| Property | Application (read-only) | | Identifies the type(s) of |
| | | | application document for |
| | | | which the module can be used |
| | | | to examine and modify. |
| Property | Creator (read-only) | | Identifies the creator of the |
| | | | module. |
| Property | Parent (read-only) | | Used to access the object |
| | | | model for the examination and |
| | | | modification component. |
| Method | Inspect (MsoDocInspectorStatus, Results) | | The method used to examine a |
| | | | document. |
| Method | Fix (MsoDocInspectorStatus, Results) | | The method used to modify a |
| | | | document. |
| Enumerations | enum | MsoDocInspectorStatus | Enumerations used to define |
| | | msoDocInspectorStatusIssueFound, | the status of the module. |
| | | msoDocInspectorStatusDocOk, | |
| | | msoDocInspectorStatusError | |

In one example, module 910 is used to examine document 620 to identify and remove hidden text. In this example, module 910 includes routines to (i) identify hidden text, and (ii) remove hidden text. For example, the following pseudocode for a routine of module 910 can be used to identify hidden text in a document.

```
public void Inspect(object Doc, out MsoDocInspectorStatus Status, out
string Result, out string Action)
{
    Doc.ActiveWindow.View.ShowHiddenText = true;
    obj oFind = Doc.StoryRanges[wdMainTextStory].Find;
    oFind.ClearFormatting( );
    oFind.Font.Hidden = true;
    oFind.Execute( );
    if (oFind.Found)
    {
        Status = MsoDocInspectorStatusFound;
        Result = “Found hidden text”;
        Action = “Remove hidden text”;
    }
    Doc.ActiveWindow.View.ShowHiddenText = false;
}
```

The following pseudocode for a routine of module 910 can be used to remove the hidden text from document 620.

```
public void Fix(object Doc, out MsoDocInspectorStatus Status, out
string Result)
{
    Doc.ActiveWindow.View.ShowHiddenText = true;
    obj oFind = Doc.StoryRanges[wdMainTextStory].Find;
    oFind.ClearFormatting( );
    oFind.Font.Hidden = true;
    oFind.Execute(Replace:=“”);
    Status = MsoDocInspectorStatusNoIssue;
    Result = “Hidden text removed”;
    Doc.ActiveWindow.View.ShowHiddenText = false;
}
```

In example embodiments, external module 910 can be associated with component 605 through a communication interface 615 of application 602. For example, in one embodiment, interface 615 is an interface such as Microsoft Corporation's Component Object Model (“COM”) interface, which allows for communication through an object-oriented interface. Other object model architectures can be used.

In the example shown, each external module, such as module 910, is initially registered with component 605. In the example embodiment, each external module, such as module 910, is registered by writing a key in the System Registry for the operating system for computer 900. For example, the following key can be added to the System Registry to register module 910 with the MICROSOFT EXCEL spreadsheet software:

HKLM\Software\Microsoft\Office\Excel\Document Inspectors\[module name]

where the “[module name]” portion of the key is a name for the module. In the example shown, the name is “HiddenTextlnspector,” although any other name can be used. In addition, the following values can be associated with the key in the System Registry.

| Name | Type | Required/Optional | Description |
|---|---|---|---|
| CLSID | SZ | required | Name of module. |
| Priority | DWORD | optional | Specifies a relative order for running of |
| | | | external modules, with “1” taking highest |
| | | | precedence. The absence of a Priority |
| | | | value automatically indicates lowest |
| | | | precedence. |
| DisabledByDefault | DWORD | optional | A non-zero value specifies that the |
| | | | Module's checkbox is not selected by |
| | | | default. If it is “0” (or not present), the |
| | | | Module is selected by default. |

Although in the example module 910 is registered with component 605 through the System Registry, other methods of registration can be used. For example, in other embodiments, one or more configuration files can be used to register an external module such as module 910 with component 605.

When the user invokes component 605 using, for example, toolbar 610, application 602 reads the System Registry and attempts to load external module 910 that is registered therein. When external module 910 is loaded, the name and description of module 910 are listed in panel 715 of interface 710, along with a checkbox that allows the user to select/deselect module 910.

In the example shown, the modules listed in panel 715 are listed in order of priority. For example, in the illustrated embodiment, internal modules 720, 730 are listed first. Next, each external module is listed in order of the System Registry “Priority” value associated with the key for each module. Other methods for selecting the order in which to list modules can be used. For example, in other embodiments, the modules can be listed in the order in which the modules are registered in the System Registry.

In addition, the checkbox associated with each module listed in panel 715 can be either selected or deselected by default. For example, in the illustrated embodiment, checkboxes for the internal modules 720, 730 are selected by default, and checkboxes for the external modules are selected/deselected based on the System Registry “DisabledByDefault” value associated with the key for each module. The user can change the state of the checkbox for a module by selecting or deselecting the checkbox in interface 710.

If internal modules 710, 720 and external module 910 are selected and the user selects button 740 to begin the examination of document 620, each module 710, 720, 910 is used to sequentially examine document 620. In the illustrated embodiment, component 605 can use the following example routine to invoke external module 910 to examine document 620.

```
Public Sub DIInspect( )
    Dim docStatus As MsoDocInspectorStatus
    Dim results As String
    ActiveDocument.DocumentInspectors(1).Inspect docStatus, results
    MsgBox(“The status of the current inspection is ” & docStatus)
    MsgBox(“Based on an inspection, the results for you document
    include ” & results)
End Sub
```

Once modules 710, 720, 910 complete examination of document 620, interface 750 is presented to the user as described above. Interface 750 includes an entry listing the results of the examination for each module, including module 910. If the user selects the link associated with module 910, module 910 is used to remove the hidden text in document 620. In the illustrated embodiment, component 605 can use the following example routine to invoke external module 910 to remove the hidden text from document 620.

```
Public Sub FixUsingDI( )
    Dim docStatus As MsoDocInspectorStatus
    Dim results As String
    ActiveDocument.DocumentInspectors(1).Fix docStatus, results
    MsgBox docStatus
    MsgBox(“The following items were fixed ” & results)
End Sub
```

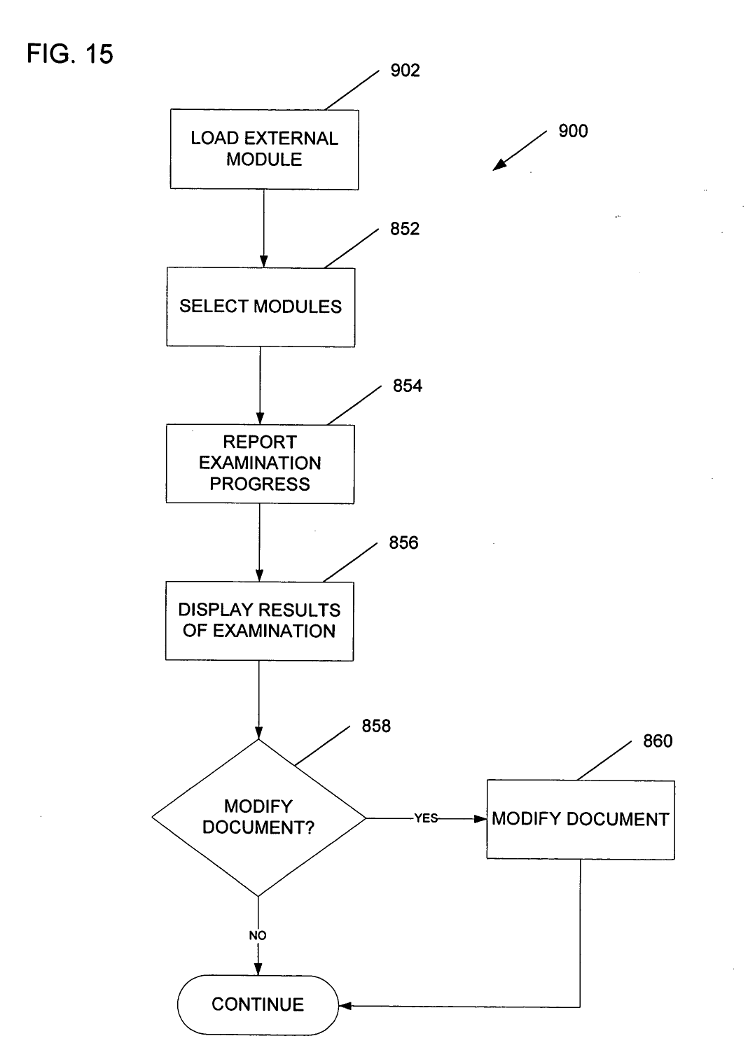

Referring now to FIG. 15, an example method 900 for examination and modification of a document is shown. Method 900 is similar to method 850 described above and includes operations 852, 854, 856, 858, and 860. However, prior to operation 852, at operation 902 any external modules are loaded. For example, operation 902 is performed when the user selects item 624 of menu 621 (see FIG. 8) to invoke component 605. After the external modules are loaded, control is passed to operation 852, and method 900 continues in a manner similar to that described above for method 850.

Although example external module 910 is used to identify and remove hidden text in a document, other external modules can be created to identify and modify a document. For example, in other embodiments, external modules can be customized to identify and remove information such as client or patient names from documents. In other embodiment, external modules can be created to identify and remove profanity or inappropriate material from documents.

For example, in one embodiment, an accounting firm can generate a document for a client A. At a later point, the firm may wish to distribute a similar document to client B. Before sending client B the document, the firm can use an external module that is specifically developed to remove client information such as client A's name for a document.

The above examples for the uses for external modules are meant to be non-limiting. External modules can be created for various other uses as well.

Because the external modules loaded by application 602 are developed by third parties, it is possible that some modules may not function correctly and could potentially result in non-functionality of the module or even disrupt functionality of component 605 or application 602. In one example, component 605 can identify and disable those modules that do not function correctly so that any adverse effects from the modules are minimized. For example, in one embodiment, component 605 writes a “blacklist” value to the key in the System Registry associated with a particular external module before running the external module for examination or modification of a document. If the module runs successfully, component 605 can subsequently remove the “blacklist” value from the key. If, however, the module does not run successfully, the “blacklist” value remains with the key associated with the external module. Component 605 can check for a blacklist value associated with a key in the System Registry for each external module before running the external module. If the backlist value is set, component 605 can skip the particular external module. In one embodiment, application 602 can provide a list of the “blacklisted” external modules so that the user can re-enable the external modules as desired.

The various embodiments described above are provided by way of illustration only and should not be construed to limiting. Those skilled in the art will readily recognize various modifications and changes that may be made to the embodiments described above without departing from the true spirit and scope of the disclosure or the following claims.

What is claimed is:

1. A computer system, comprising:
an application programmed to create a document;
a component including at least one internal module programmed to examine and modify the document to remove hidden information or metadata; and
a communications interface for an external module programmed to examine and modify the document, wherein the communications interface is programmed to allow the component to communicate with the external module.

2. The system of claim 1, further comprising the external module.

3. The system of claim 1, wherein the application is programmed to allow a user to invoke the component to examine and modify the document.

4. The system of claim 3, wherein the application includes a menu with an item that is selected by the user to invoke the component to examine and modify information in the document.

5. The system of claim 1, further comprising a first user interface programmed to allow a user to select or deselect the internal module used to examine the document.

6. The system of claim 5, further comprising a second user interface programmed to allow the user to select or deselect the internal module used to modify the document.

7. The system of claim 1, further comprising a first user interface programmed to allow a user to select or deselect the internal module and the external module used to examine the document.

8. A method for examining and removing information from a document, the method comprising:
allowing a user to create a document;
providing a menu including an item programmed to allow for finalization of the document;
upon selection of the item, loading a component programmed to examine the document to identify information as part of the finalization of the document; and
presenting the user with results of the examination of the document by the component.

9. The method of claim 8, further comprising modifying the document using the component.

10. The method of claim 9, wherein modifying further comprises removing the information from the document.

11. The method of claim 8, further comprising:
providing an internal module programmed to examine the document;
providing a communications interface for an external module programmed to examine the document; and
loading the internal module and the external module upon selection of the item.

12. The method of claim 11, further comprising providing the external module programmed to examine the document.

13. The method of claim 11, further comprising allowing the user to select or deselect use of the internal module and the external module to examine the document.

14. The method of claim 8, further comprising identifying hidden information or metadata associated with the document.

15. A computer-readable medium having computer-executable instructions for performing steps comprising:
allowing a user to create a document;
providing a menu including an item programmed to allow for finalization of the document;
upon selection of the item, loading a component programmed to examine the document to identify information as part of the finalization of the document; and
presenting the user with results of the examination of the document by the component.

16. The computer-readable medium of claim 15, further comprising modifying the document using the component.

17. The computer-readable medium of claim 16, wherein modifying further comprises removing the information from the document.

18. The computer-readable medium of claim 15, further comprising:
providing an internal module programmed to examine the document;
providing a communications interface for an external module programmed to examine the document; and
loading the internal module and the external module upon selection of the item.

19. The computer-readable medium of claim 18, further comprising providing the external module programmed to examine the document.

20. The computer-readable medium of claim 18, further comprising allowing the user to select or deselect use of the internal module and the external module to examine the document.
